(19) United States
(12) Patent Application Publication
(10) Pub. No.: US 2003/0171993 A1
(43) Pub. Date: Sep. 11, 2003

(54) Electronic payment transaction via sms

(76) Inventor: Pierre Chappuis, Gumligen (CH)

Correspondence Address: Paul J Esatto, Scully Scott Murphy & Presser, 400 Garden City Plaza, Garden City, NY, 11530, US

(21) Appl. No.: 10/343,564

(22) PCT Filed: Jul. 26, 2001
(86) PCT No.: PCT/EP01/08678

(51) Int. Cl. G06F 17/60; H04L 9/00; H04K 1/00

(52) U.S. Cl. 705/16; 705/64; 705/40

(57) ABSTRACT

The present invention makes available a method for handling electronic payment transactions using a mobile terminal 1, in particular a mobile telephone, which method comprises the following steps:

transmission of a payment request from the mobile terminal 1 to a payment handling centre 6;

transmission of the desired payment modalities from the mobile terminal 1 to the payment handling centre 6;

allocation of an individual transaction code or clearance code for each payment transaction, and

transmission of the allocated transaction code or clearance code to the mobile terminal 1 and/or a payee 8.

The present invention relates to a method for handling electronic payment transactions using a mobile terminal, to a software program for implementing such a method and to a telephone card for a mobile telephone in which such a software program is stored.

The background of the present invention is the idea, which has recently become very widespread, of using, for example, a mobile telephone as a means of payment and in particular as a substitute for a credit card. The use of credit cards as means of payment has the result that, at present, information on the credit card holder remains behind on the copy of the record kept by the contracting company. Given the existence of this information, it cannot at present be ruled out that unauthorised persons can be able to make purchases via the Internet and to initiate or implement the payment using the misused credit card.

The information present on the credit card is built up as follows:

Credit card company

Name and forename of credit card holder

Credit limit visible via coloration or card marking

Credit card number (16 digit)

Expiry date

Signature of credit card holder

Magnetic strip with PIN code for cash withdrawal at ATM

As a new development, photo of cardholder on reverse side

It is true that the introduction of the photo on the reverse side has increased the security level in reducing misuse of stolen credit cards, provided the credit card is handed over to the contracting company during payment, in order to execute the payment by passing the card through a reader or making a copy by mechanical means.

Each payment using a credit card leaves behind a record on which the most important features are visible in unencrypted form, namely:

Credit card company or clearing partner

Number of cardholder

Name and forename of credit card holder

Expiry date

Signature of cardholder

The company paybox.net AG (Internet address: www.paybox.net) has presented a system for payment transactions which makes it possible for final customers to make payments using their mobile telephones on the Internet, in stationary retail commerce, to mobile service providers and to each other. To make a payment, the merchant telephones the freephone number of the paybox Company. He is then asked for the amount and the mobile telephone number of the customer. This data must then be input by the merchant using a keyboard. Finally, the paybox company telephones the customer and has the payment authorised by the customer. To conclude the transaction, the successful payment is confirmed to the transaction payers. The communication between the merchant who wishes to issue the payment order and the centre for handling payment transactions therefore takes place via a traffic channel of a telephone line.

This has the disadvantage that this traffic channel can be blocked, suffer interference or otherwise not be successfully usable. Moreover, the known system is not set up to implement payments by means of a credit card account.

Starting from this known state of the art, it is an object of the present invention to provide a system for electronic payment transactions which is designed for payments by means of credit card accounts. In addition, the system is to permit secure communication between the party which orders the payment and a payment handling centre.

This object is achieved according to the invention by the features of the independent claims. The dependent claims further refine the central idea of the present invention in an especially advantageous manner.

According to the invention, therefore, a method for implementing electronic payment transactions using a mobile terminal such as a mobile telephone is provided. In this method, a payment request is first sent from the mobile terminal to a payment handling centre. At the same time as or after transmission of the payment request, the payment modalities are sent from the mobile terminal to the payment handling centre. The payment modalities can include, for example, the payee, the number of the credit card used, the amount for payment, etc. Each payment transaction is allocated an individual transaction code or clearance code characterising the transaction, which is transmitted to the mobile terminal and/or to a payee.

Through the transmission of the individual transaction or clearance code, it can be ensured that all participating parties (mobile terminal user on one side and payee on the other) obtain certainty on the success or failure of a payment transaction. In addition, proof of a successful payment for the payment handling centre is facilitated by the provision of an individual transaction or clearance code for the participating parties, in particular the payee.

The individual transaction or clearance code can be generated, for example, by the payment handling centre on receiving the payment request.

If—for example, because the payee lacks a network address—direct communication between payee and payment handling centre is possible only in the direction from the payee to the payment handling centre (with current payment terminals this is usually the case even when they are connected to a central station) it is especially advantageous if the individual transaction or clearance code is generated by the payee and transmitted to the payment handling centre, and if the payment handling centre sends the transaction or clearance code to the mobile terminal only after completion of payment.

It can thereby be ensured that the payee obtains certainty about the success or failure of a payment transaction even without direct communication from the payment handling centre to the payee (e.g. by comparing the individual transaction or clearance code transmitted from the payment handling centre to the mobile terminal with the individual transaction or clearance code generated by the payee). Transmission of a separate clearance code to the recipient of payment can therefore be dispensed with.

A further advantage of this procedure can be seen in the fact that possibilities of manipulation by the user of the mobile terminal are small.

In a preferred embodiment, the individual transaction code or clearance code contains information about the payee and/or the amount to be paid.

This enables the payee to check the payment modalities generated by the user of the mobile terminal and transmitted to the payment handling centre (in particular with respect to the payee and the amount for payment). In addition, allocation of a plurality of items of information relating to a certain transaction (e.g. payment modalities and transaction code) is simplified for the payment handling centre.

To prevent possible attempts at manipulation using “obsolete” individual transaction or clearance codes, it is also advantageous if the individual transaction or clearance code is provided with a freely definable validity time limit (e.g. one hour, one day, one week).

According to a further preferred embodiment, an individual key is generated by the payee for each payment transaction and transmitted to the payment handling centre. The allocation of the individual transaction or clearance code is then effected according to this preferred embodiment by the payment handling centre and with reference to the individual key transmitted by the payee, in such a way that the payee can check the validity of the individual transaction or clearance code with reference to the underlying individual key.

An advantage of this embodiment is that the individual clearance or transaction code is effected only with the collaboration of the payee, but not solely by the payee.

It can also be ensured in this way that a counterfeit transaction code or clearance code presented by a mobile terminal user to the payee is recognised as invalid. The security of the method according to the invention against manipulation is thereby further increased.

Even when an individual key generated by the payee is used, it is advantageous if the individual key contains information about the payee and/or the amount to be paid, and additionally is provided with a freely definable validity time limit.

To be able to dispense with transmission of an additional confirmation of payment, it is also especially advantageous if the transmission of the individual transaction or clearance code by the payment handling centre constitutes clearance of the payment transaction.

Because even modern payment terminals which are connected to a central station—and which can, for example, be regarded as payees in the context of the invention—do not usually have an individual network address, direct addressing of an individual payment terminal and therefore direct communication in the direction of the payment terminal is not, as a rule, possible.

In such cases, it is advantageous if transmission of the individual transaction or clearance code from the payment handling centre to the payee is effected via the mobile terminal.

In that case, the transaction or clearance code received by the payment clearance centre can be transmitted onwards from the mobile terminal to the payee preferably via an air interface (for example an infrared or Bluetooth connection).

According to a preferred embodiment of the present invention, the communication between the mobile terminal and the payment handling centre takes place at least partially (with respect to time and/or route) via a data channel or a signalling channel of an air interface.

The data channels or signalling channels of known air interfaces, such as the GSM standard or the GPRS or UMTS standards, have the advantage over traffic channels that they represent the fastest and most stable type of connection. In addition, communication via a data channel or a signalling channel can be readily encrypted so that the transmitted data can be tapped only with difficulty by unauthorised third parties.

The communication between the mobile terminal and the payment handling centre can take place at least partially (with respect to time and/or route) by means of the so-called SMS (Short Message Service) service of the GSM standard or by means of a corresponding short message service of a different standard (e.g. GPRS or UMTS).

The SMS (Short Message Service) allows a mobile participant to transmit messages having a length of 160 characters in the GSM standard. The transmission is effected by means of a so-called Short Message Service Center (SMS center) of the mobile telephone operator. Messages can be temporarily stored at the SMS center and then transmitted on to the mobile participant. In this case, the message is transmitted via free capacity in the signalling channel and therefore does not take up any capacity in the traffic channels. At the receiver's end, the message can be stored on the so-called SIM card (Subscriber Identity Module) or directly in the mobile telephone. Storage space for e.g. 10 short messages each of 160 characters is reserved on the SIM card. The mobile participant therefore has the possibility of inputting short messages via the keypad of the mobile station and transmitting them to other participants via the SMS center. If a receiver in the mobile telephone network is temporarily not reachable, the short message is stored at the SMS center and is sent out only when the participant connects to the mobile telephone network again using his SIM.

In this case, communication between the mobile terminal and the payment handling centre can take place using data which are read from a memory in the mobile terminal.

The memory can be, for example, permanently incorporated in the mobile telephone or provided on a card located in the mobile terminal, e.g. a SIM card or a “smart card” (“smart card” is generally understood to mean a card corresponding to a SIM card and having an inbuilt processor).

The data read from the memory, which can be stored statically or preferably generated dynamically, should be suitable to characterise the mobile terminal concerned in an unambiguous manner.

The payment modalities can contain credit card information.

In this case, the credit card information is not made accessible to the payee. Rather, the credit card information is transmitted only in encrypted form from the mobile terminal to a data processing centre for payment handling (payment handling centre).

The credit card information can be input manually into the mobile terminal.

Alternatively, it can be stored on a card located in the mobile terminal and issued e.g. in cooperation with a credit card company.

After a successful payment transaction, the information on the completed payment transaction can be stored in a memory of the mobile terminal. The memory can be provided in particular on a card located in the mobile terminal.

Such storage makes improved cost monitoring possible for the user of the mobile telephone.

The transaction information can then be read out by an authorised user of the mobile terminal and/or transmitted to another device (home PC). In that device, the transaction information can optionally be evaluated and, for example, processed by means of an account management program.

Depending on the configuration of the payment modalities, the payment can be executed immediately or with a time delay.

According to a further aspect of the present invention, a software program for implementing the method described is provided.

Furthermore, according to the present invention, a phone card for a mobile telephone is provided which includes a memory in which a software program for implementing such a method is stored.

In addition, according to the present invention a server for handling electronic payment transactions is provided which includes a software program for implementing the method according to the invention.

Further features, advantages and characteristics of the present invention will be apparent in more detail from the following description of embodiments with reference to the Figures of the accompanying drawings.

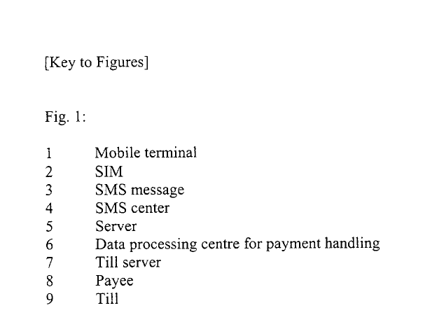

FIG. 1 shows a system for electronic payment transactions using a mobile terminal according to the present invention;

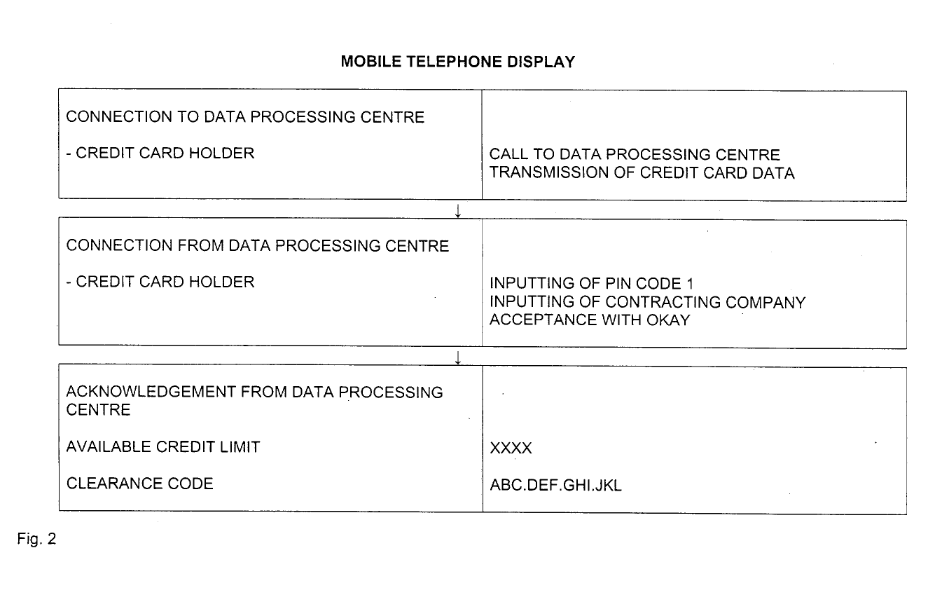

FIG. 2 shows a flow diagram of the interaction between a customer's mobile telephone and a payment terminal;

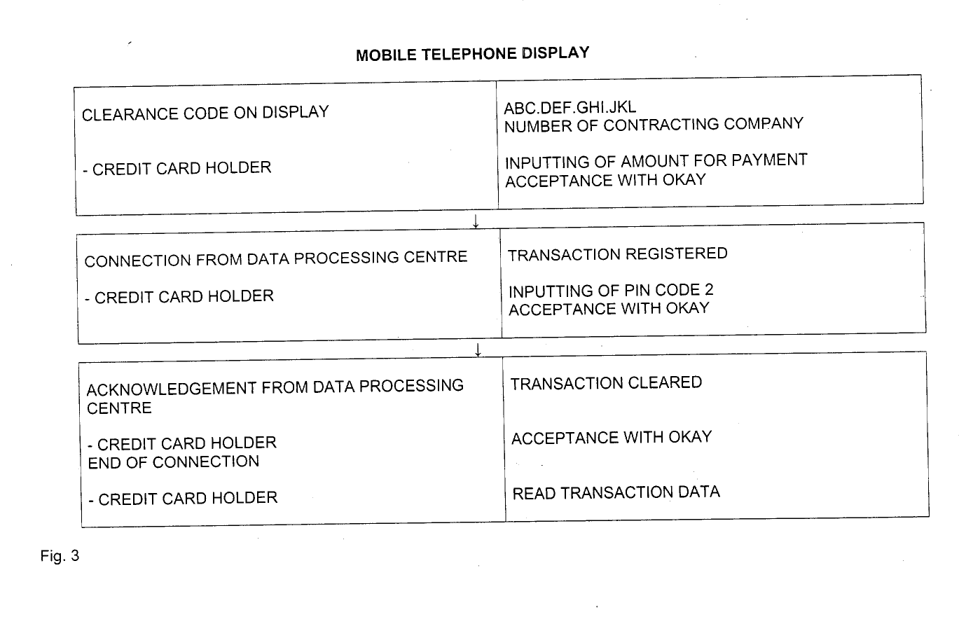

FIG. 3 shows the payment process in the case of use of the customer's mobile telephone and the payment terminal;

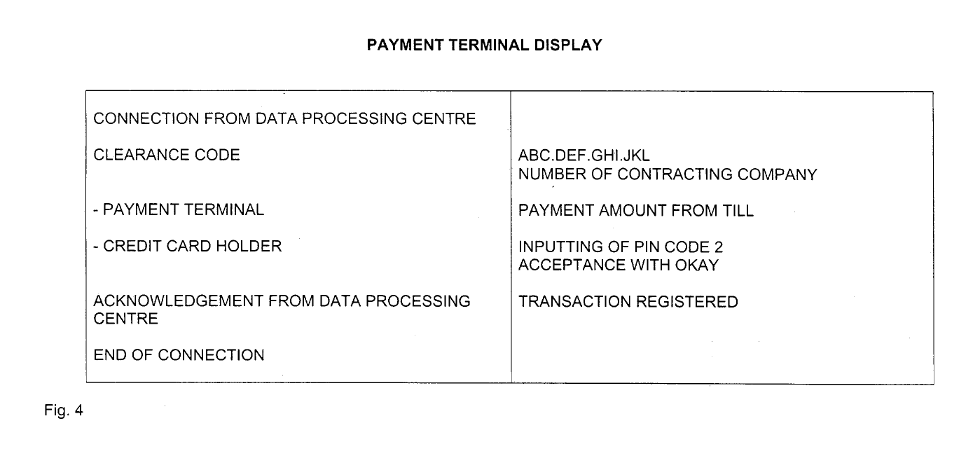

FIG. 4 shows the display which appears on the screen of a payment terminal during the payment process;

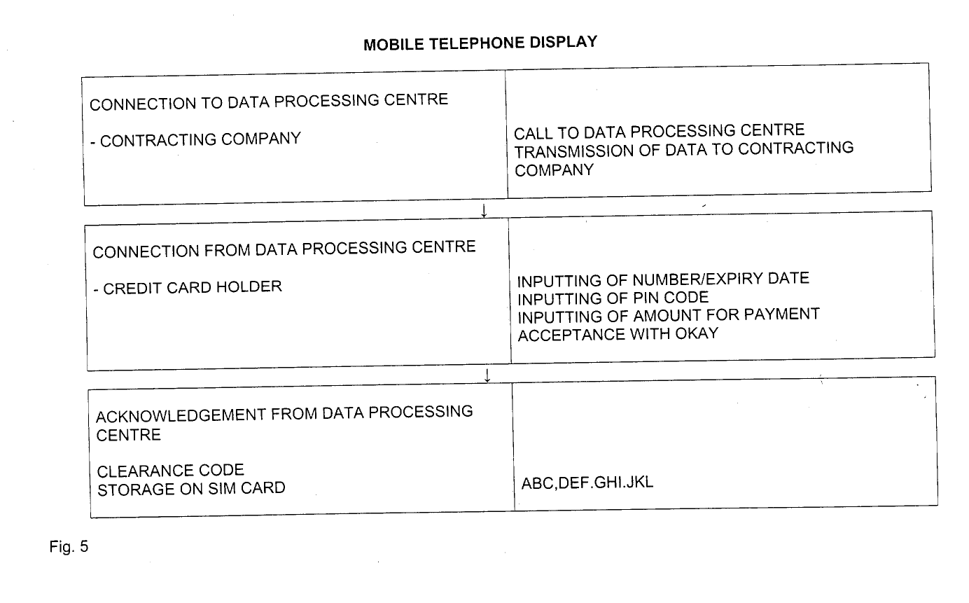

FIG. 5 shows the flow diagram and the display of the mobile telephone in the case of use of a mobile telephone of a contracting company;

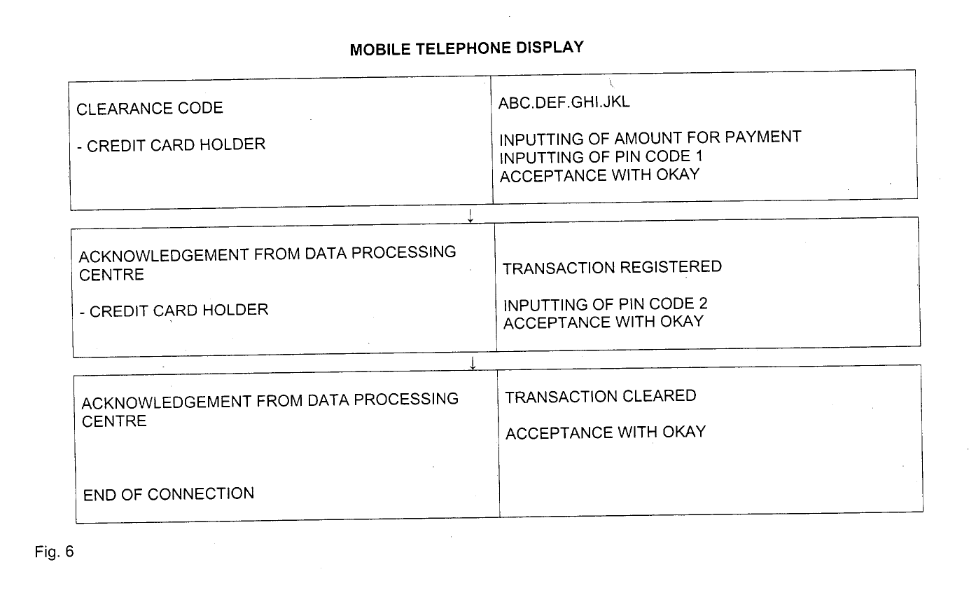

FIG. 6 shows the display of a mobile telephone during the payment process using a mobile telephone of a contracting company;

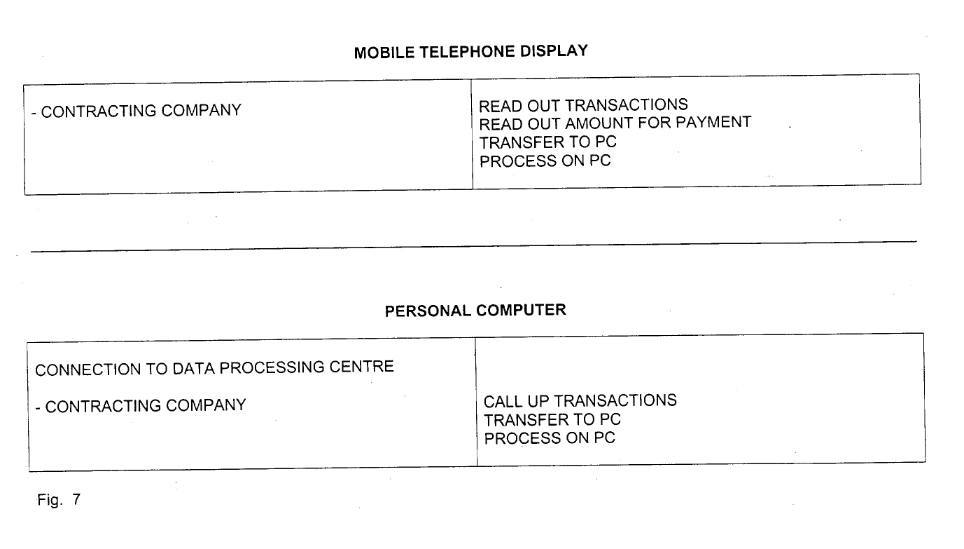

FIG. 7 shows the display of a mobile telephone and of a personal computer (PC) in clearance mode;

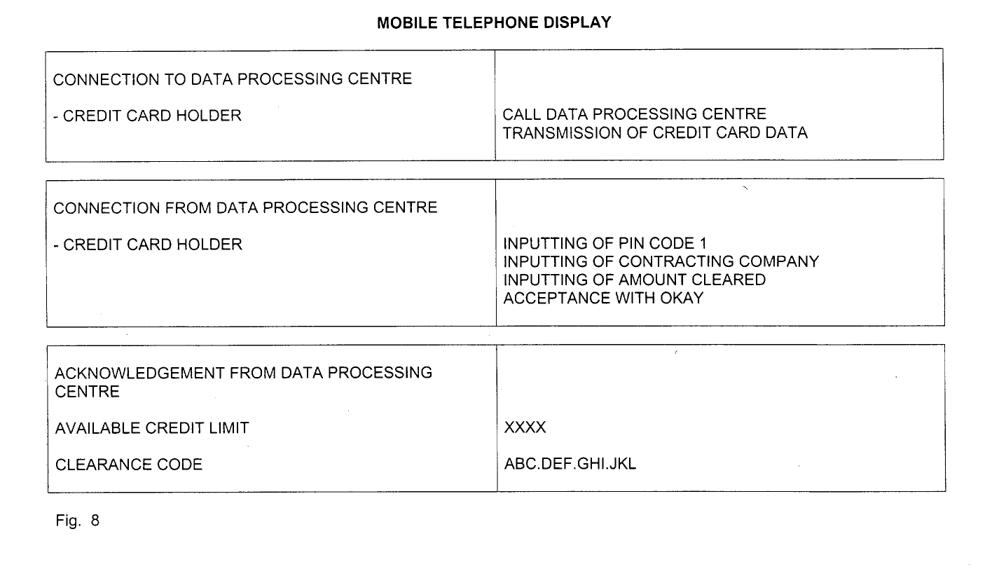

FIG. 8 shows a flow diagram for the display of a mobile telephone for a payment process using the customer's mobile telephone or a payment terminal in the case of a time-delayed payment (checking in at a hotel), and

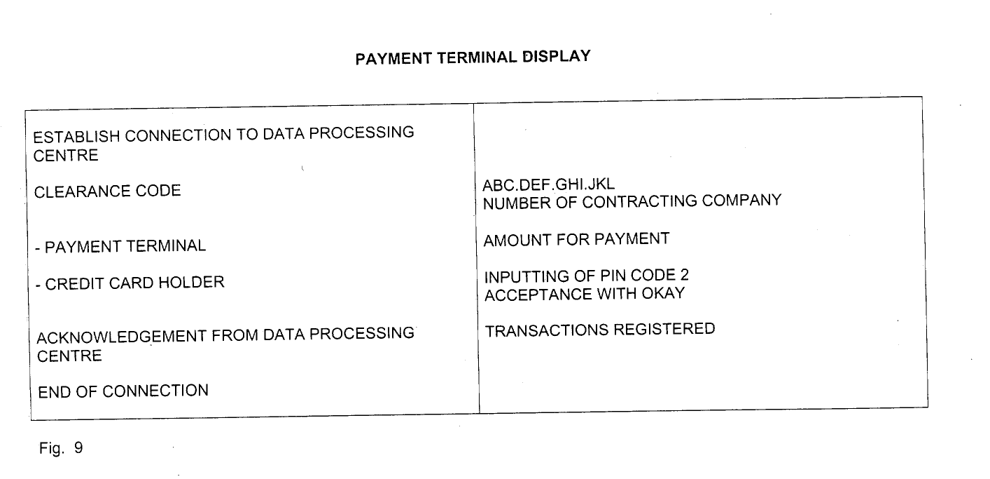

FIG. 9 shows a flow diagram for the display of a payment terminal for a payment process using the customer's mobile telephone or a payment terminal in the case of time-delayed payment (checking in at a hotel).

With reference to FIG. 1, a system which can be used in implementing the present invention will be elucidated first. It is assumed in the scenario that a customer with a mobile terminal, in particular a mobile telephone 1, wishes to pay at a payment terminal 9 of a payee (for example, a supermarket or the like). This payment is to be made electronically via an account to which a certain credit card of the customer is allocated.

The mobile terminal (mobile telephone) 1 of the user has a known SIM card 2 which has a memory function. With the mobile telephone 1 and the SIM card 2, the user can exchange SMS messages with a first SMS center 4 via a first air interface 3. This exchange via the first air interface 3 is effected in the embodiment illustrated by means of the GSM standard.

Because only a data or signalling channel is necessary for the present invention, the mobile telephone can be so configured that it can send and receive only SMS messages but is not equipped to establish a traffic channel (speech channel).

The SMS center 4 which is administered, for example, by a network operator is connected to a server 5 which is connected on one side to a data processing centre for handling payments by credit card (clearing centre) 6 and on the other to the payee 7 by means of a data line 10. The connecting server 5 can be functionally and geographically unified with the data processing centre for payment handling 6.

More precisely, the server 5 is connected to a payment server 7 of the payee 8, the payment server 7 being connected in turn to the different payment terminals 9 of the payee 8.

Furthermore, if data are to be transmitted directly between mobile terminal 1 and payee 8, a local second air interface 11 can be provided if needed between the payee 8, more precisely a payment terminal 9 of the payee 8, and the mobile terminal 1. This second air interface 11 can be, for example, a Bluetooth or infrared connection.

With reference to FIGS. 2 to 7, the operational sequence of the present invention will now be elucidated:

To implement the concept of this solution, the following components and elements are required:

Credit card

Credit card number

Available credit limit updated by the data processing centre (clearing centre)

PIN code

Transaction code or approval code

Optionally, key of the payee

Mobile telephone with special software

Regarding hardware, either the customer's mobile telephone or the mobile telephone available at the payment point (principally the customer's mobile telephone) is used; the SIM memory of this mobile telephone can be so configured that it performs the following operations:

In the case of the customer's mobile telephone, the relevant information is read directly from the memory via a short call and the connection with the corresponding credit card company or data processing centre is established, this information being:

Identification of credit card holder

Credit card number

Expiry date

The communication costs are charged to the credit card holder or to the contracting company.

In the case of the local mobile telephone of the contracting company (payee) the relevant information is read directly from the SIM memory and the connection to the credit card company or data processing centre is established, this information being:

Number of the contracting company

The communication costs are charged to the contracting company.

For security reasons, the SMS platform is currently appropriate for the transactions and the communication between the contracting company and the credit card holder.

Payment with the Credit Card Holder's Own Mobile Telephone

Payment Against Record

In the case of payment with the customer's mobile telephone, as represented in FIGS. 2, 3 and 4, the following sequence is prescribed:

By dialling the telephone number of the data processing centre (clearing centre) from the integrated SIM memory the mobile telephone sends the credit card number of the credit card holder to the credit card company or data processing centre by SMS message (FIG. 2).

The connection is established and inputting of the PIN code by the credit card holder together with the number of the contracting company (FIG. 2) via the keypad of the mobile telephone is requested.

Checking of the inputted data by the data processing centre and clearance of information to the credit card holder

The data processing centre (credit card company) then transmits back the following information to the mobile telephone, where it is displayed on the screen (FIG. 2):

Available credit limit of the cardholder updated by the data processing centre

Individual 12-character (alphanumeric) transaction code as payment clearance, which code is then transferred to the record of the payee (contracting company of the data processing centre) as the basis for clearance. The first 2 characters of the transaction code can serve as identification of the data processing centre

The customer and credit card holder acknowledges the number of the contracting company on his mobile telephone, types the payment amount into his mobile telephone and transmits this information back to the data processing centre (FIG. 3).

Alternatively, a second inputting of the PIN code or inputting of a further PIN code is conceivable and possible as an additional security feature.

Conclusion through acknowledgement by the credit card company or data processing centre to the mobile telephone of the customer and confirmation of the transaction with OK (FIG. 3) by the customer on the mobile telephone

End of connection.

The communication costs of the transaction are charged to the credit card holder or the contracting company, if no freephone number can be used.

This procedure prevents the number of the credit card holder from ever being made known to the contracting company, thereby ruling out further use of this information by unauthorised parties, e.g. for fraudulent purchases via the Internet, which misuse requires only this key information to make a transaction.

This application is of interest in that the transaction information can be stored in the SIM memory and read into or transferred to the customer's PC by means of IR or read-out device. The information concerned is the following:

Date and time of the transaction

Number of the contracting company

Clearance code of the credit card company or the data processing centre

Inputted payment amount.

First Alternative Embodiment

According to a first alternative embodiment, the following sequence is prescribed:

By dialling the telephone number of the data processing centre (payment handling centre) from the integrated SIM memory, the mobile telephone transmits the credit card number of the credit card holder to the credit card company or data processing centre by SMS message.

The connection is established and inputting of the PIN code by the credit card holder on the keypad of the mobile telephone is requested.

Checking of the inputted data by the data processing centre and clearance of information to the credit card holder.

The data processing centre (credit card company) then transmits the following information back to the mobile telephone where it is displayed on the screen:

Available credit limit of the cardholder updated by the data processing centre;

The customer and credit card holder types the number of the contracting company and the payment amount into his mobile telephone and transmits this information (payment modalities) back to the data processing centre.

Independently of this, the payee allocates to the payment process an individual 12-character (alphanumeric) transaction code which contains information on the payee and the payment amount. In addition, the first 2 characters of the transaction code can serve as identification of the data processing centre. In addition, the transaction code includes a validity limit of, for example, 30 minutes.

The individual transaction code is transmitted from the payee to the payment handling centre.

The payment handling centre compares the information contained in the individual transaction code with the payment modalities received from the mobile telephone.

In case of agreement, the individual transaction code is sent to the mobile telephone as acknowledgement of payment.

End of connection.

The communication costs of the transaction are charged to the credit card holder or to the contracting company if no freephone number can be used.

Second Alternative Embodiment

According to a second alternative embodiment, the following sequence is prescribed:

By dialling the telephone number of the data processing centre (payment handling centre) from a memory of the mobile telephone, the mobile telephone transmits the credit card number of the credit card holder to the credit card company or data processing centre by short message.

The connection is established and inputting of the PIN code by the credit card holder together with the number of the contracting company and the payment amount on the keypad of the mobile telephone is requested.

Checking of the inputted data by the data processing centre and clearance of information to the credit card holder.

The data processing centre (credit card company) then transmits the following information back to the mobile telephone where it is displayed on the screen:

Available credit limit of the cardholder updated by the data processing centre;

Inputted payment modalities (payee and payment amount);

The credit card holder acknowledges the payment modalities with OK.

The payee allocates to the payment process an individual key which contains information on the payee and the payment amount. The key is further characterised by a freely definable validity time limit.

Transmission of the key from the payee to the payment handling centre.

The payment handling centre compares the information contained in the individual key (payee, payment amount) with the payment modalities received from the mobile telephone.

In case of agreement, an individual 12-character (alphanumeric) transaction code is generated and allocated to the payment process by the payment handling centre with reference to the key received from the payee.

The individual transaction code is transmitted to the mobile telephone as acknowledgement of payment.

End of connection

Checking of the transaction code for validity by the payee by means of the key used.

The communication costs of the transaction are charged to the credit card holder or to the contracting company if no freephone number can be used.

In a preferred embodiment of the present invention, the individual transaction code is transmitted from the mobile telephone 1 to a payment terminal 9 of the payee 8. This can be effected both manually and alternatively via a local air interface 11. The local air interface 11 can preferably be a Bluetooth or infrared connection.

A procedure of this kind is advantageous in particular if a payment terminal 9 of the payee 8 cannot be directly addressed by the payment handling centre. Adaptation of existing payment terminals is in general possible without difficulty. Because of the local air interface, a “manual” transference of the transaction code to the payee is unnecessary even in the above-mentioned case, so that the method according to the invention can be significantly accelerated.

The above-described alternative embodiments and a preferred configuration of the present invention can be applied analogously to the further embodiments described below.

Payment via the Customer's Mobile Telephone or the Payment Terminal of the Contracting Company

This application is of importance since large distributors with payment terminals at present regret that only a fraction of purchases are made by means of cashless payment transactions. According to those responsible, the main reason is the long transaction time, which currently is approx. 30 seconds.

According to the invention, it is made possible for the customer to prepare the payment transaction while he is still in the queue at the till and has sufficient time to establish the appropriate communication.

In the case of payment with the customer's mobile telephone, the following sequence is therefore obligatorily provided:

By dialling the telephone number of the data processing centre from the integrated SIM memory, the mobile telephone transmits the credit card number of the credit card holder to the credit card company or the data processing centre.

The connection is established and the data processing centre requires the credit card holder to input the PIN code to the mobile telephone together with the number of the contracting company or the payment terminal at which the payment transaction is being carried out (this number is displayed prominently at every till).

Checking of the inputted data and clearance of the information to the credit card holder

The credit card company then transmits the following information back and displays this on the screen of the credit card holder's mobile telephone:

Available and updated credit limit of the credit card holder

12-character (alphanumeric) transaction code as payment clearance

Credit card company then additionally transmits the following information to the payment terminal of the contracting company:

Simultaneous transmission of the 12-character (alphanumeric) transaction code as payment clearance to the display of the contracting company or the payment terminal (but above all without the credit card number or the name of the credit card holder)

The payment amount generated directly by the till also appears on the display of the payment terminal.

VARIANT A: The credit card holder accepts the number of the contracting company and types the payment amount into his mobile telephone and sends this information back to the data processing centre with OK.

VARIANT B: Alternatively, this process can be effected via the payment terminal by inputting of the PIN code+OK.

Alternatively, a second inputting of the PIN code would be conceivable and possible as an additional security feature.

Conclusion through acknowledgement by the credit card company or the data processing centre and acceptance of the transaction with OK on the mobile telephone and/or the payment terminal

End of connection.

The communication costs of the transaction are again charged to the credit card holder or the contracting company if no freephone number can be used.

This procedure prevents the number of the credit card holder from ever being made known to the contracting company, ruling out further use of this information by unauthorised parties, for example, for fraudulent purchases via the Internet which require only this key information to be transacted.

This application is of interest in that the transaction information can be stored in the SIM memory and can be read in or transmitted by means of IR or reader to the customer's PC. The information concerned is as follows:

Date and time of transaction

Number of contracting company

Clearance code of credit card company or data processing centre

Inputted payment amount.

In addition, through this type of connection payments are possible even if the online connection between contracting company and data processing centre is inoperative, suffers interference or is interrupted. It is therefore advantageous that the payment is made secure by the transaction code.

Payment via the Customer's Mobile Telephone in the Case of Transactions on the Internet According to the Bottom Illustration in FIG. 7

Precisely in the case of requests for payment by credit card on the Internet, extreme caution is called for as the credit card holder gives out the vital data of his card without having any guarantee that this data can under no circumstances be acquired for fraudulent use.

It is therefore absolutely appropriate for the payment to be safeguarded by means of a code which is transmitted in advance by the credit card company to the credit card holder.

The payment is initiated using the customer's mobile telephone. For this reason, the following sequence is provided:

By dialling the telephone number of the data processing centre from the integrated SIM memory, the mobile telephone transmits the credit card number of the credit card holder to the credit card company or the data processing centre.

The connection is established and the data processing centre requires the credit card holder to input the PIN code to the mobile telephone together with the number of the contracting company for which the payment on the Internet is intended.

Checking and clearance of the information to the credit card holder

The credit card company then transmits the following information back and displays this on the screen of the credit card holder's mobile telephone:

Available and updated credit limit of the credit card holder

12-character (alphanumeric) transaction code as payment clearance.

The credit card holder accepts the number of the contracting company and types the payment amount into his mobile telephone and sends this information back to the data processing centre with OK.

Alternatively, a second inputting of a PIN code would be conceivable and possible as an additional security feature.

Conclusion through acknowledgement by the credit card company or the data processing centre and acceptance of the transaction with OK on the mobile telephone

End of connection.

The communication costs of the transaction are charged to the credit card holder or the contracting company if no 0800 number can be used.

This procedure prevents the number of the credit card holder from ever being made known to the contracting company, ruling out further use of this information by unauthorised parties, for example, for fraudulent purchases via the Internet, which require only this key information to be transacted.

This application is of interest in that the transaction information can be stored in the SIM memory and can be read into or transmitted to the customer's PC by means of IR or reader. The information concerned is as follows:

Date and time of transaction

Number of contracting company

Clearance code of credit card company or data processing centre

Inputted payment amount.

Payment Using a Mobile Telephone of the Contracting Company

In case of payment using the mobile telephone of the contracting company according to FIGS. 5 to 7, the following sequence is provided:

Telephone number from integrated SIM memory transmits number of contracting company to credit card company or data processing centre.

Connection is established and inputting of the following information by the credit card holder is requested:

Information on the credit card holder, i.e. credit card number and expiry date

PIN code by the credit card holder

Payment amount

Transmission of the data to the credit card company or data processing centre

Credit card company or data processing centre transmits the following information back and shows said data on the display:

12-character (alphanumeric) CODE as payment clearance which is transmitted to the record of the contracting company as the basis for clearance and is simultaneously stored on the SIM card

The credit card holder types in his PIN code as acceptance of the payment amount to release the payment and sends the information to the credit card company or data processing centre.

The following information remains on the SIM card of the local mobile telephone:

Date and time of transaction

Clearance code of credit card company or data processing centre

Inputted payment amount

Under no circumstances is the credit card number registered by the contracting company.

The communication costs of the transaction are charged to the contracting company if no 0800 number can be used.

This application is of interest in that the transaction information can be stored in the SIM memory and can be read into or transferred to the contracting company's PC by means of IR or reader. The information concerned is as follows:

Date and time of transaction

Clearance code of credit card company or data processing centre

Inputted payment amount

The credit card number is not, however, registered by the contracting company.

Here, too, this procedure prevents sensitive information on the credit card holder from being made known to the contracting company, thereby ruling out further use of this information by unauthorised parties, for example, for fraudulent purchases on the Internet, which require only this information to be transacted.

Payment via the Customer's Mobile Telephone or the Payment Terminal of the Contracting Company with Delayed Payment (e.g. Hotel) According to FIGS. 8, 9

When checking in, the hotel guest is requested to make known the data of his credit card to the reception so that payment can later be made without delay when checking out. At the same time this represents a guarantee of payment for the contracting company.

When checking in, the following sequence using the customer's mobile telephone is obligatorily prescribed:

Telephone number from integrated SIM memory transmits credit card number of credit card holder to credit card company or data processing centre.

Connection is established and inputting of PIN code by credit card holder together with number of contracting company or of a terminal at which the payment transaction can be carried out later is requested, together with the amount cleared by the credit card holder for the later payment of the account.

Checking and clearance of the information to the credit card holder

The credit card company then transmits the following information back and displays this on the screen of the credit card holder's mobile telephone:

Available and updated credit limit of the credit card holder (by data processing centre)

12-character (alphanumeric) CODE as payment clearance

Credit card company then additionally transmits the following information to the payment terminal of the contracting company:

Simultaneous transmission of the 12-character (alphanumeric) CODE as payment clearance on the display of the contracting company or the payment terminal (but, above all, without the credit card number or the name of the credit card holder)

The payment cleared by the credit card holder also appears on the display of the terminal.

VARIANT A: The credit card holder accepts the number of the contracting company and sends this information back to the data processing centre with OK.

VARIANT B: Alternatively, this process can be effected via the terminal by inputting of the PIN code+OK.

Alternatively, a second inputting of a PIN code would be conceivable and possible as an additional security feature.

Conclusion through acknowledgement by the credit card company or the data processing centre and acceptance of the transaction with OK on the mobile telephone or the payment terminal

End of connection.

For payment and checking out, the following sequence is prescribed:

Contracting company establishes connection to credit card company or data processing centre with reference to the stored transaction code and the payment amount transmitted.

Credit card company or data processing centre then transmits back the following information:

Confirmation of the transaction code and of the registered payment amount

The payment amount appears on the display of the terminal.

The credit card holder is then requested to input the following information to the terminal:

Confirm payment amount with OK (or if necessary correct amount)

Input PIN code to clear the transaction.

End of connection.

The communication costs of the transaction are charged to the contracting company.

Acknowledgement by the data processing centre on the mobile telephone of the credit card holder with the following information:

Date and time of transaction

Number of contracting company

Clearance code of credit card company or data processing centre

Inputted payment amount

This application is of interest in that the transaction information can be stored in the SIM memory and can be read into or transferred to the customer's PC by means of IR or reader.

The communication costs of the transaction are charged to the credit card holder.

This procedure prevents the number of the credit card holder from ever being made known to the contracting company, ruling out further use of this information by unauthorised parties, for example, for fraudulent purchases via the Internet, which require only this key information to be transacted.

Cash Card

A prerequisite of the current use of the so-called cash card is that said card is recharged at a point established for this purpose, preferably at the bank. The downloaded amount is then stored in a memory in the cash card and reduced by every payment process analogously to a cash payment. The cash card therefore represents a kind of electronic purse which can be recharged via terminals.

It will be possible in the future, however, to recharge this cash card at home by means of a telebanking function (transaction of bank business via an online connection). A prerequisite for this is a reader/writer (Class 3) and a corresponding contract with the bank, which also provides the appropriate software.

Because this cash card in any case contains all the identification features of the account holder, and because the reader/writer fully meets the security requirements of banks, the communication must be established via a landline connection.

For implementation, therefore, the following sequence is provided:

Insert cash card in reader/writer

Reading of amount remaining on cash card

Establishment of communication with the bank

Contract number is read from the cash-card and transmitted to the bank or the allocated data processing centre

A key (“security key”) is read from the cash card and transmitted

Inputting of a PIN CODE via a keypad of the reader/writer

Inputting of the amount with which the cash card is to be recharged

Transfer of the amount to the cash card

Reading of the present amount on the cash card

End of connection

Remove cash card from reader/writer.

In the future, this application will also be able to strengthen customer loyalty in that special cash cards which can be provided with customer-specific supplements will be issued by companies. As an example, a cash card to which a photo of the holder can be applied is possible. Children can have the card recharged with the appropriate amount by adults and consume the amount in a cashless manner.

Transaction Monitoring

With a Class 3 reader/writer in combination with a PC, it is possible at any time to download all transactions in updated form to the customer's PC via the Internet.

For implementation, the following sequence is provided:

Insert credit card in reader/writer

Establish communication with the data processing centre of the credit card company

Credit card number is read by the reader/writer and transmitted to the data processing centre

A key (“security key”) is read from the credit card and transmitted to the data processing centre

Inputting of a PIN CODE via a keypad of the reader/writer

Dialog as prompted by screen (e.g. date from-to)

Download transactions

End of connection

Remove credit card from reader/writer.

Further processing takes place via suitable user programs.

1. A method for handling electronic payment transactions using a mobile terminal (1), in particular a mobile telephone, comprising the following steps:
transmission of a payment request from the mobile terminal (1) to a payment handling centre (6);
transmission of the desired payment modalities from the mobile terminal (1) to the payment handling centre (6),
characterised by the further steps:
allocation of an individual transaction code or clearance code for each payment transaction;
transmission of the allocated transaction code or clearance code to the mobile terminal (1) and/or a payee (8).

2. A method according to claim 1, characterised in that the individual transaction code or clearance code is generated by the payee and transmitted to the payment handling centre, and in that the payment handling centre transmits the transaction code or clearance code to the mobile terminal (1) only after the payment has been made.

3. A method according to any one of claims 1 or 2, characterised in that the individual transaction code or clearance code contains information on the payee and/or the amount of the payment to be made.

4. A method according to any one of the preceding claims, characterised in that the individual transaction code or clearance code is provided with a freely definable validity time limit.

5. A method according to claim 1, characterised in that for each payment transaction an individual key is generated by the payee and is transmitted to the payment handling centre and in that the allocation of the individual transaction code or clearance code by the payment handling centre with reference to the individual key transmitted by the payee is effected in such a way that the payee can check the validity of the individual transaction code or clearance code with reference to the underlying individual key.

6. A method according to claim 5, characterised in that the individual key contains information on the payee and/or the amount of the payment to be made.

7. A method according to any one of claims 5 or 6, characterised in that the individual key is provided with a freely definable validity time limit.

8. A method according to any one of the preceding claims, characterised in that the transmission of the individual transaction code or clearance code constitutes clearance of the payment transaction.

9. A method according to any one of the preceding claims, characterised in that the transmission of the transaction code or clearance code from the payment handling centre to the payee is effected via the mobile terminal.

10. A method according to claim 9, characterised in that the transaction code or clearance code received by the payment handling centre from the mobile terminal is transmitted onwards via an air interface to the payee.

11. A method according to claim 10, characterised in that the air interface is an infrared or Bluetooth connection.

12. A method according to any one of the preceding claims, characterised in that the communication between the mobile terminal (1) and the payment handling centre (6) is effected at least in part via a data channel or signalling channel of an air interface (3).

13. A method according to claim 12, characterised in that the communication between the mobile terminal (1) and the payment handling centre (6) is effected at least in part by means of the SMS service of the GSM standard.

14. A method according to claim 12, characterised in that the communication between the mobile terminal (1) and the payment handling centre (6) is effected at least in part by means of a short message service of the GPRS or the UMTS standard.

15. A method according to any one of the preceding claims, characterised in that data read from a memory (2) in the mobile terminal (1) are used in the communication between the mobile terminal (1) and the payment handling centre (6).

16. A method according to claim 15, characterised in that the data unambiguously identify the mobile terminal (1) concerned and are either stored statically or generated dynamically.

17. A method according to claim 15 or 16, characterised in that the data are read from a card (2) located in the mobile terminal (1).

18. A method according to any one of claims 15 to 17, characterised in that the data are read from a SIM card (2).

19. A method according to any one of claims 15 to 17, characterised in that the data are read from a smart card (2) located in the mobile terminal.

20. A method according to any one of the preceding claims, characterised in that the payment modalities contain credit card information.

21. A method according to claim 20, characterised in that the credit card information is not accessible to the payee (8).

22. A method according to claim 20 or 21, characterised in that the credit card information is input manually to the mobile terminal (1).

23. A method according to any one of the preceding claims, characterised in that the communication between the mobile terminal (1) and the payment handling centre (6) is effected in an encrypted manner.

24. A method according to any one of the preceding claims, characterised in that after the payment transaction information regarding the transaction is stored in a memory (2) of the mobile terminal (1).

25. A method according to claim 24, characterised in that the transaction information can be read out by an authorised user of the mobile terminal (1) and/or transferred to a different device.

26. A method according to any one of the preceding claims, characterised in that the payment is effected immediately or in a time-delayed manner according to the payment modalities.

27. A software program, characterised in that it makes possible the implementation of a method according to any one of the preceding claims.

28. A telephone card for a mobile telephone, characterised in that it includes a memory in which a software program for implementing a method according to any one of claims 1 to 26 is stored or implemented.

29. A server for handling electronic payment transactions, characterised in that it includes a software program for implementing a method according to any one of claims 1 to 26.
